(19) United States
(12) Patent Application Publication
(10) Pub. No.: US 2006/0247406 A1
(43) Pub. Date: Nov. 2, 2006

(54) Process for the continuous production of high-viscosity crosslinkable silicone compositions

(75) Inventors: Rudolf Reitmeier, Burghausen (DE); Johann Schuster, Emmerting (DE); Stephan Aigner, Burghausen (DE); Alois Schlierf, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 11/410,683

(22) Filed: Apr. 25, 2006

(30) Foreign Application Priority Data
Apr. 28, 2005 (DE) 10 2005 019 874.0

(51) Int. Cl. C08L 83/04; C08G 77/06; C08K 3/00

(52) U.S. Cl. 528/25; 524/588

(57) ABSTRACT

A process for the continuous production of organopolysiloxane compositions which vulcanize at elevated temperature and have a viscosity of at least 500 Pa·s at 25° C., involves mixing and homogenizing high-viscosity organopolysiloxanes and crosslinking additives in a kneading cascade having at least two kneading chambers arranged in series proximate one another, containing two axially parallel kneading tools which can be driven in the same or opposite directions, and which are connected to one another by means of openings transverse to the axes of the kneading tools, with the first kneading chamber having a feed opening and the last kneading chamber having a discharge opening, and the temperature in the kneading chambers containing crosslinking additives being not more than 95° C.

### BACKGROUND OF THE INVENTION

1. Field of the Invention

The invention relates to a process by means of which organopolysiloxane compositions which vulcanize at elevated temperature can be produced in a kneading cascade.

2. Background Art

The incorporation of temperature-sensitive additives such as peroxides, or H-Si-functional crosslinkers and platinum catalysts, into long-chain vinyl-functional organopolysiloxane/filler mixtures (HTV or HCR rubber) has been carried out for decades on roll mills, usually 2-roll mills. Although these readily coolable roll mills make it possible to produce excellent quality blends which can be vulcanized to produce various elastomers by the end processor/customer, in the case of highly filled and thus very highly viscous silicone formulations such as HTV rubber (also known as solid rubber), even when using low-temperature peroxides, this traditional process is relatively time-consuming and labor-intensive, in particular when a plurality of low-viscosity, e.g. oily, additives are to be incorporated.

Admixing of additives required by the end processor in relatively large machines, e.g. closed kneaders, is substantially more economical (more productive). However, due to the heat of friction, which is considerable in the case of filled high-viscosity HTV rubber and which increases with increasing total mass, a high degree of cooling is necessary, or otherwise the amount to be mixed as well as the reactivity of the crosslinkers/accelerators will be restricted. In addition, large kneaders require relatively long filling and emptying times with associated temperature control, which limits the productivity per ton of end product.

Attempts were therefore made as early as the 1990s to produce such silicone mixtures continuously in screw extruders, as are commonly used for thermoplastics and also occasionally for organic rubbers. Reference may be had to the DIK Seminar “Kontinuierliches Mischen”, Oct. 25-26, 1999, in particular the presentation by H. Schaarschmidt from Berstorff on the twin-screw extruder (TSE). Even in the case of corotating TSEs, standard technology for processing thermoplastics, the product temperature increases to a relatively high degree in the case of highly filled HTV rubbers as a result of the heat of friction, so that the specific power (HTV mixture/time×extruder length) is very limited despite intensive cooling, particularly in the case of reactive crosslinking systems which react below 100° C. EP1110696 A2 describes the compounding of crosslinker-free HTV base mixtures filled with reinforcing fillers in a twin-screw extruder, preferably at 140-180° C., the autogenous mixer temperature. In this process, a separate cooling step is necessary before mixing in thermolabile additives.

In addition, twin-screw extruders having good mixing action are problematic in terms of metal abrasion, especially in the case of stiff HTV rubbers, i.e. HTV rubbers which are highly filled with silica, so that undesirable “gray streaks” can be formed even at moderate pressures.

DE 196 17 606 A describes a “continuous process for producing storage-stable organopolysiloxane compositions”, in which prehydrophobicized silicas are mixed into vinyl-Si-terminated polydimethylsiloxanes in a kneading machine having kneading chambers which are arranged in series next to one another. In the example described in the Conterna® kneading machine, temperatures of 100° C. were reached after 15 minutes when using a relatively low-viscosity polydimethylsiloxane (20,000 mPa·s in the example). The analogous comparative experiment on the production of the base composition in a twin-screw extruder using the same raw materials gave a temperature rise to 150° C. after only 2 minutes.

In DE 103 13 941 A, high-viscosity HTV silicone compositions are compounded from the solid polymer and reinforcing silica raw materials in such a kneading cascade. After only 6 chambers without heating or cooling, exit temperatures of 150° C., which rose to above 200° C. during optimal operation, are obtained. In addition, the fillers were introduced via powder transport/weighing and the HTV polymers are introduced at temperatures above 100° C. and thus at a significantly lower viscosity than at room temperature, effectively as a liquid.

### SUMMARY OF THE INVENTION

It was an object of the invention to provide a continuous process by means of which crosslinkable high-viscosity organopolysiloxane compositions which vulcanize at elevated temperature can be produced in a particularly economical way. This and other objects are achieved by processing the vulcanizable composition raw materials at relatively low temperature in a special kneading cascade having reversibly driven axially parallel kneading tools, and transfer openings transverse to the tool axes.

### BRIEF DESCRIPTION OF THE DRAWINGS

FIG. 1 depicts schematically one embodiment of the subject invention.

### DETAILED DESCRIPTION OF THE PREFERRED EMBODIMENT(S)

The invention thus provides a process for the continuous production of organopolysiloxane compositions which vulcanize at elevated temperature and have a viscosity of at least 500 Pa·s measured at 25° C., which comprises mixing and homogenizing high-viscosity organopolysiloxanes and crosslinking additives in a kneading cascade having at least two kneading chambers which are arranged in series proximate one another, each containing two axially parallel kneading tools which can be driven in the same or opposite directions, the chambers connected to one another by means of openings transverse to the axes of the kneading tools, with the first kneading chamber having a feed opening and the last kneading chamber having a discharge opening, and the temperature in the kneading chambers containing crosslinking additives (H) being not more than 95° C.

Those skilled in the art have hitherto assumed that low temperatures and good mixing-in of crosslinkers cannot be achieved in a kneading cascade. However, it has been surprisingly discovered that this is not so when proceeding in accordance with the present invention. The low temperatures and homogenous distribution of crosslinking additives and, if appropriate, further additives in the kneading cascade, make it possible to achieve better economics compared to the abovementioned prior art. In the inventive process, high throughputs can be processed without partial vulcanization of the crosslinking systems both in the case of very stiff organopolysiloxane compositions and in the case of temperature-sensitive additives, so that a significantly higher productivity compared to roll mills, screw extruders or discontinuous mixers is obtained.

Even after relatively long campaigns, well-homogenized crosslinkable organopolysiloxane compositions always result, so that specific quality control costs are lower than for mixtures produced according to the prior art. When using the same raw materials, the storage stability, in particular of production line forms, is improved compared to the organopolysiloxane compositions produced in standard mixers or coolable kneaders.

The temperature in the kneading cascade, especially in the kneading chambers containing crosslinking additives, can be kept low, for example by means of kneading hooks which introduce little energy into the mixture, by means of large heat-exchange areas, or by means of intensive cooling using a liquid coolant. The organopolysiloxanes, the crosslinking additives and any further additives, are preferably mixed and homogenized at a constant mass ratio.

The high-viscosity organopolysiloxanes can be one organopolysiloxane or a mixture of various organopolysiloxanes. It is possible to use all organopolysiloxanes which are suitable for the production of HTV, LSR, RTV-1 and RTV-2 compositions. Such components are well known to those skilled in the art. These include linear, branched, cyclic or resin-like organopolysiloxanes which may also contain functional groups, usually for the purpose of crosslinkability. Preference is given to using linear organopolysiloxanes such as polydimethylsiloxanes having a degree of polymerization of from 50 to 9000. Preferred organic radicals of the organopolysiloxanes are methyl, phenyl, vinyl and trifluoropropyl, most preferably, methyl. The functional groups which are preferably present in the polyorganosiloxanes are —SiOH, —SiOR, Si-vinyl and —SiH, most preferably vinyl. Particularly preferred organopolysiloxanes are organopolysiloxanes which are customarily used for producing heat-curing HTV silicone compositions and have a Brabender value of from 200 to 900 daNm measured at 25° C., in particular from 400 to 700 daNm.

Preferred organopolysiloxanes correspond to the average general formula (1)
R¹ₐR²_{b}SiO_{(4-a-b)/2} (1),
where the radicals
R¹ are identical or different monovalent Si-bonded radicals selected from among —H, —OH, —OR, where R is a C₁-C₁₀-hydrocarbon radical, and unsubstituted or halogen- or cyano-substituted C₁-C₁₀-hydrocarbon radicals which contain at least one aliphatic carbon-carbon multiple bond and which may be bound to silicon via a divalent organic group,
R² are identical or different monovalent Si-bonded, unsubstituted or halogen- or cyano-substituted C₁-C₁₀-hydrocarbon radicals which contain no aliphatic carbon-carbon multiple bonds,
a is a nonnegative number from 0 to 1 and
b is a nonnegative number from 1 to 2.1.

R¹ is preferably an alkenyl group which is able to react with an SiH-functional crosslinker or with a peroxide. Preferred are alkenyl groups having from 2 to 6 carbon atoms, e.g. vinyl, allyl, methallyl, 1-propenyl, 5-hexenyl, ethynyl, butadienyl, hexadienyl, cyclopentenyl, cyclopentadienyl, and cyclohexenyl, preferably vinyl and allyl. This list is illustrative and not limiting.

Divalent organic groups via which the alkenyl groups may be bound to silicon of the polymer chain comprise, for example, oxyalkylene units such as units of the general formula (2)
—(O)ₚ[(CH₂)_{q}O]ᵣ— (2),
where
p is 0 or 1, in particular 0,
q is from 1 to 4, in particular 1 or 2, and
r is from 1 to 20, in particular from 1 to 5.

The oxyalkylene units of the general formula (2) are bound at the left in the formula above to a silicon atom.

The radicals R¹ can be bound in any position on the polymer chain, in particular at the terminal silicon atoms.

R² preferably has from 1 to 6 carbon atoms. Particular preference is given to methyl and phenyl.

The structure of the polyorganosiloxanes of the general formula (1) can be linear, cyclic or branched. The content of trifunctional and/or tetrafunctional units which lead to branched polyorganosiloxanes is typically very low, preferably not more than 20 mol %, in particular not more than 0.1 mol %.

Particular preference is given to using organopolysiloxanes which contain vinyl groups and whose molecules correspond to the general formula (3)
(ViMe₂SiO_{1/2})_{c}(ViMeSiO)_{d}(Me₂SiO)ₑ(Me₃SiO_{1/2})_{f} (3),
where Vi is a vinyl radical and Me is a methyl radical, the nonnegative integers c, d, e and f satisfy the following relationships: c+d≧1, c+f=2, 1000<(d+e)<9000, preferably 3000<(d+e)<7000, and 0<(d+1)/(d+e)<1, preferably 0<(d+1)/(d+e)<0.1.

As crosslinking additives, preference is given to using peroxides, and also to Si—H-functional siloxanes in conjunction with platinum or rhodium catalysts.

As peroxide crosslinkers, preference is given to crosslinkers such as alkyl peroxides, ketal peroxides and, in particular, the more reactive aroyl peroxides. Particular preference is given to 2,5-di-tert-butylperoxy-2,5-dimethylhexane, dicumyl peroxide, 1,1-di(tert-butylperoxy)-3,3,5-trimethylcyclohexane and, in particular, bis(4-methylbenzoyl) peroxide and bis(2,4-dichlorobenzoyl) peroxide. These are preferably introduced as a paste in silicone oil or organopolysiloxane.

As further additives, it is possible to add, for example, accelerators, inhibitors, stabilizers, pigments, color pastes, flame-retardant or thermally conductive metal oxide additives, substances which improve the electrical properties, for example aluminum trihydrate, fillers, organopolysiloxane modifiers, structure improvers, processing aids, dispersants, hydrophobicizing agents, for example silazanes, silanol-containing oligosiloxanes, destructuring agents, plasticizers, bonding agents, heat stabilizers and antioxidants. As inhibitors for Si—H-functional siloxanes in combination with platinum or rhodium catalysts, preference is given to ethynylcyclohexanol.

In the process, color pastes and stabilizers are preferably introduced as pigment or metal oxide masterbatch or as carbon black masterbatch, i.e. as a paste in silicone oil or organopolysiloxane. These additive/siloxane masterbatches are most preferably have a viscosity not higher than 2000 Pa·s, because the outlay or the cost level for the metering equipment is more favorable as compared to the use of relatively high-viscosity organopolysiloxane. The amounts of the additives to be admixed are preferably from 0.2 to 10%, based on the organopolysiloxane compositions (MH).

Fillers include all fillers suitable for use in silicone compositions, with mixtures of various fillers also being suitable. Suitable fillers are, for example, silicas, carbon blacks, metal oxides, carbonates, sulfates, nitrides, diatomaceous earth, clays, chalks, mica, metal powder, activated carbon, powders of organic polymers, etc. It is important that the viscosity of the filler-containing organopolysiloxane compositions is, as a result of the filler content, significantly higher than the viscosity of the organopolysiloxane which is to be mixed continuously into this filler-containing silicone composition. Preference is given to reinforcing fillers, i.e. fillers having a specific surface area measured by the BET method of at least 50 m²/g, preferably 50-500 m²/g, for example pyrogenic silica, silica hydrogels which have been dewatered with retention of structure, i.e. aerogels, other types of precipitated silicon dioxide, and carbon blacks. The particularly preferred pyrogenic silicas, precipitated silicas and carbon blacks may have been subjected to a surface treatment, e.g. to improve their dispersibility. Prehydrophobicized oxidic reinforcing fillers having a carbon content of at least 0.5% by weight resulting from the hydrophobicization are particularly preferred. Silicone resins of the M_{w}DₓT_{y}Q_{z} type which in pure form are solid at room temperature, in particular, can also be present.

The filler content of the organopolysiloxane composition is preferably from 5 to 80% by weight, in particular from 10 to 50% by weight. Particular preference is given to producing organopolysiloxane compositions having a filler content of from 20 to 40% by weight.

As structure improvers, preference is given to organopolysiloxanes having a viscosity of from 10 to 200 mPa·s measured at 25° C., in particular from 20 to 150 mPa·s. Silanol-containing oligosiloxanes and dimethyl(oligo or poly)siloxanes which are end-blocked by trimethylsilyl groups are preferred. The radicals of the structure improvers are preferably selected from among methyl, phenyl, vinyl and hydroxyl groups.

The proportion of solid additives having a low specific surface area can be from <1% to >150% relative to the organopolysiloxane. If aluminum trihydrate (ATH; BET surface area: 2-9 m²/g) is to be incorporated to improve the electrical properties, for example, from 10 to 55% of this additive in the mixture is particularly preferred.

In the process, the organopolysiloxanes used may have been premixed with additives. As a base mixture of organopolysiloxanes and additives, it is in principle possible to use all relatively high-viscosity silicone compositions containing vinyl groups and containing no crosslinking additives. Preference is given to using HTV polymer/silica mixtures having a viscosity in the range from 1000 to 100,000 Pa·s or from 10 to 150 Mooney units (final Mooney value, ML(1+4 min) at 23° C.; DIN 53523), which are also marketed for various applications in compounding, in particular for roll mill and extruder blends. These are described, for example, in DE 103 13 941 A1 and can be procured from Wacker-Chemie among the Elastosil® R (rubber) HTV grades.

The kneading cascade preferably comprises at least 3 and not more than 10 kneading chambers, most preferably a maximum of 6 chambers. The last chamber preferably has pump blades for discharge of the product. The starting materials can be introduced and mixed in in any order; the starting materials can also be introduced into one or more chamber(s) of the kneading cascade. Preference is given to introducing all the organopolysiloxane into the first chamber. It is also possible to introduce part of the organopolysiloxane into a later chamber, e.g. to lower the viscosity of the organopolysiloxane composition in the first chambers. The planned crosslinking additives and any additives required can be introduced into all chambers; preference is given to introducing no filler into the last chamber. It is possible to introduce the total amount of filler required into, for example, only one/two or three of the first chambers, but distribution of the additives, fillers and any additives required over all chambers is also possible.

The oxides which are active in the stabilizer and color pastes can be introduced as powder and preferably mixed in in the front chambers of the cascade mixer. In the case of pulverulent and low-melting crosslinkers, e.g. dicumyl peroxide, too, this is a more advantageous process variant compared to an additive siloxane masterbatch.

If structure improvers are used, then these are preferably introduced into the first chambers, in particular into the first chamber. Preference is given to introducing no oily additive into the last chamber.

The kneading cascade preferably has at least three, in particular at least five, kneading chambers.

Between individual kneading chambers or all kneading chambers, it is possible to install screens, baffle plates or slider valves to bank up the organopolysiloxane compositions. These elements can be adjustable in terms of their position and the opening which they leave free. The residence time in the individual chambers can be influenced in this way. The kneading tools are preferably kneading hooks, kneading blades, rollers or polygonal plates.

Apart from the feed opening of the first kneading chamber, further feed openings which lead into the individual kneading chambers or are located between two kneading chambers are preferably present in the kneading machine. Each kneading chamber preferably has one feed opening. In particular, the feed openings of the first and third kneading chambers are suitable for the introduction of solids and the other feed openings are preferred for the introduction of liquids or expressible pastes. Since there is barely any free gas space in the kneading cascade, protective gas can be dispensed with, if desired.

In the process of the invention, each kneading chamber of the cascade preferably has a separate drive so that the control of the intensity of the mixing process in each chamber can be optimized precisely.

The kneading chambers are preferably heatable and/or coolable; in particular, they can be operated individually at different temperatures. The first chambers are preferably heatable, e.g. to incorporate fusible solids. The last kneading chambers are preferably able to be cooled well for the mixing-in of temperature-sensitive crosslinking additives and further additives, and for removal of the heat generated by friction.

The temperatures of the composition in the kneading chambers in the process of the invention preferably range from room temperature to not more than 150° C., more preferably from 40° C. to not more than 95° C., in particular in the last chambers toward the outlet. In particular, the temperature of the kneading chambers in which crosslinking additives (H) are present is preferably not more than 80° C., more preferably not more than 70° C.

The kneading tools are preferably mounted in a cantilever fashion. The end wall of the housing at the bearing end is then provided with openings for the drive shafts of the kneading tools. The housing of the kneading chambers preferably has a separation point running transverse to the tool axes, so that the part of the housing away from the mounting can be moved away from the separation point and the kneading tools in the axial direction of the drive shafts. A kneading machine configured in this way is particularly easy to clean and is thus advantageous when the product is changed. Such a kneading machine is described in EP 807509 A.

The homogeneous organopolysiloxane composition is preferably fed onto a shaping discharge machine after the last kneading chamber preferably via a flexible connecting piece or a conveyor belt.

Although the organopolysiloxane composition displays excellent storage stability straight after the kneading cascade because of the low temperature, this storage stability can be improved further by installation of a continuous, preferably cooled, roller unit downstream of the kneading cascade. The composition is preferably discharged onto a shear roll which can be cooled well and on which additives can also be mixed in.

The downstream discharge machine is, if present, preferably a feed extruder which builds up pressure, in particular a twin-screw extruder having contrarotating conical feed screws and/or a gear pump.

With this admission pressure, a strainer sieve can also be installed in front of the perforated discharge plate for the desired product form in the process of the invention. Preference is given to using a self-lubricating gear pump with a sieve-change attachment for this purpose.

In a further preferred embodiment, a perforated plate with rotating knives for the continuous production of cylindrical pellets of the organopolysiloxane compositions is installed downstream of the discharge machine. This on-line pelletization is particularly economical because the pelletization step which is carried out separately in the standard process can be carried out by the normal personnel for the continuous plant without intermediate storage of the organopolysiloxane compositions.

For the constant (over time) introduction of the crosslinker-free organopolysiloxanes, if appropriate mixed with additives, in particular fillers, a feed extruder which builds up pressure, optionally with a gear pump installed downstream, can preferably be used in the kneading cascade. The organopolysiloxanes, if appropriate mixed with additives, are preferably brought without preconditioning into a preliminary form, e.g. pellets or powder. Conical multiscrew extruders, in particular contrarotating twin-screw machines, are preferably used for this purpose.

When twin-screw extruders are used in combination with gear pumps, a particularly constant mixing ratio with the additives (A) can be ensured. Twin-screw extruders, e.g. extruders known under the name Moriyama, are suitable in the process for all solid silicone rubbers, regardless of their form and viscosity, and replasticize even very thixotropic pastes and pastes filled with high levels of finely divided silica, even those having stiffening/demixing tendencies.

The addition of the liquid or paste-like additives required by the end processor for vulcanization in the precise amounts needed for the formulation can likewise be carried out via metering apparatuses which build up pressure in the process. Simple piston or diaphragm pumps or gear pumps or displacement pumps having rotor/stator transport are preferably used for this purpose, depending on the flowability of the active ingredients. The throughput of the various additive pumps is preferably coupled with the above-described introduction of the organopolysiloxane, if appropriate mixed with additives, into the first chamber of the kneading cascade by means of a process control system. This ensures both the correct metering ratio and also makes throughput optimization by the plant operators easier.

In the case of solids which are to be mixed in in a relatively large amount, in particular flame-retardant or thermally conductive metal oxide additives these additives are preferably fed in via a differential balance and incorporated in one or more kneading chambers.

Although it has not been explicitly stated above, the machines used in the process of the invention can contain further components known per se, e.g. metering and transport devices, measuring and regulating facilities, for example for pressure, temperature and volume flows, and also valves, components usually required for heating or cooling or transport and packaging facilities.

The meanings of all the symbols in the formulae presented heretofore are independent of one another. Unless indicated otherwise, all amounts and percentages specified in the following examples are by weight and all pressures are 0.10 MPa (abs.). All viscosities were determined at 20° C.

In the examples below, the following materials were used:

HTV rubber A: High-viscosity solid rubber mixture comprising 40 parts of reinforcing silica having a BET surface area of at least 200 m²/g, per 100 parts of polydimethylsiloxane having a mean degree of polymerization of 5500, few crosslinkable vinyl groups and also processing aids. This HTV mixture has a Mooney viscosity (ML(1+4 min) at 23° C.; DIN 53523) of about 40 and after vulcanization, e.g. by means of peroxide, has a Shore A hardness of 60.

HTV rubber B: Highly filled kneader intermediate comprising 50 parts of reinforcing silica having a BET surface area of about 200 m²/g per 100 parts of HTV vinyl solid polymer (as for rubber A) and a minor amount of short-chain OH-functional siloxanes, which further comprises 68 parts of quartz and has a Mooney final viscosity of about 53. After crosslinking, a Shore A hardness of about 80 is obtained.

### EXAMPLE 1

### Process According to the Invention (Pilot Plant)

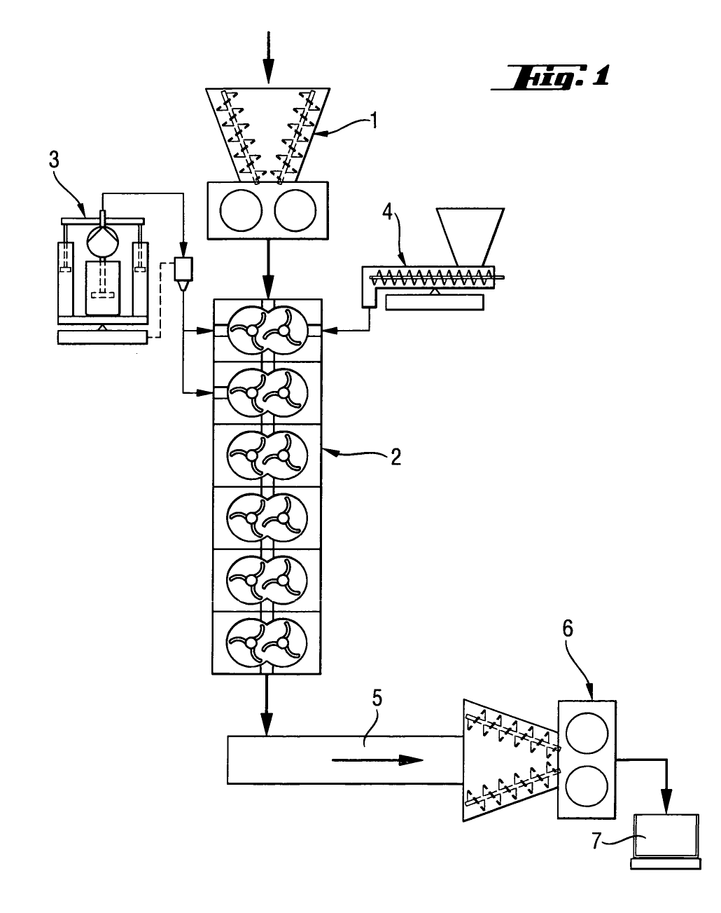

The process is described with the aid of FIG. 1:

A Conterna® kneading cascade (2) from IKA Maschinenbau Janke & Kunkel GmbH & Co.KG, Staufen, was used for blending. The kneading cascade (2) had 6 chambers each having a volume of 5 liters and individual regulatable blade blocks. The total throughput was from 150 to 250 kg/h, depending on the oil content of the additives.

For the introduction (1) of the mixture of organopolysiloxane with filler and the discharge or shaping (6) of the organopolysiloxane composition, a conical twin-screw extruder CTE 75 from Colmec (Milan/It.) was used in each case.

The additive pastes were for this purpose metered in under the control of a PCS via drum expression apparatuses (3) from ViscoTec (Töging/Germany) with eccentric screw pumps and pressure monitoring.

Precisely 170 kg/h of HTV rubber A were injected into chamber 1 of the water-cooled kneading cascade (2) by means of the above CTE 75 with a downstream gear pump. At the same time, precisely 3.06 kg/h of a 50% strength paste of di(4-methylbenzoyl) peroxide in silicone oil (Degussa/Peroxid-Chemie) and 2.1 kg/h of the color paste Elastosil® FL Blau-5015 (commercial product of Wacker Chemie AG) were metered in each case via the offtake stations ViscoMT-XS into the 1st and 2nd chambers of the kneading mixer. The speed of rotation of the cooled blades was from 15 to 50 rpm. After a residence time of about 10 minutes, the homogeneously blue rubber mixture was discharged at a temperature of 49° C. via a conveyor belt (5) and transported into the shaft of a further, cooled transport extruder (6). From this screw machine which builds up pressure (6), the product was pushed through a perforated plate having an edge length of 60×100 mm mounted at the outlet. After capping of the rubber bars to a length of 340 mm, the finished sales product was packed in 20 kg cartons (7) or went to quality control testing.

Vulcanization at 135° C./10 min gave a smooth test plate having a Shore A hardness of 61. The rapid testing of various intermediate samples from a 2 metric ton batch on a vulcameter gave identical T90 values and thus indicated excellent homogeneity of the sales product.

### EXAMPLE 2

### Process According to the Invention, Pilot Plant

220 kg/h of HTV rubber B instead of the HTV rubber A of example 1 were fed by means of the metering extruder (1) into the kneading cascade (2), but 1.2% of a 45% strength paste of 2,5-di-tert-butylperoxy-2,5-dimethylhexane in silicone rubber (commercially available as DHBP-45-PSI from Peroxid-Chemie) was now introduced via the drum offtake station (3). To color the composition, 8.8 kg/h of color granules Elastosil® FG Schwarz-9005 were added via a Flexwall metering instrument (from Brabender) directly into the intake funnel of the 2nd kneading chamber, and these had likewise been mixed in homogeneously at the outlet of the last chamber.

In addition to example 1, a cooled gear pump GP112 with screen changing attachment (from Colmec/Milan) was mounted at the outlet of the conical feed extruder (6) before shaping into the product form, so that a 100 μm strainer could be installed here, too.

An L8 continuous strip which had, according to the requirements of quality testing (pressing at 165° C./10 min.; plurality of samples of the batch for the vulcameter test: T90 values identical within measurement uncertainty), been homogeneously mixed was produced at temperatures below 60° C. with the aid of a 10×40 mm perforated plate.

This highly filled HTV mixture has a high oil resistance.

### COMPARATIVE EXAMPLE 1

### Process Not According to the Invention

When blending the same components of the crosslinking-active safety cable mixture described under example 2 in a well cooled 1 metric ton mixer, e.g. a water-cooled sigma kneader, a mixing and emptying time of at least 4 hours is necessary because the internal temperature has to remain below 100° C. to avoid partial vulcanization.

With the filling time of the 1 metric ton mixer of at least 1 hour for 1 plant operator and the working time for the subsequent 100 μm strainer procedure (at least about 2-3 hours for 1 metric ton), a total productivity of only 130-140 kg/h up to packaging is obtained here.

In comparison thereto, the process of the invention gives a calculated productivity per 1 operator including on-line straining of over 220 kg/h even for the relatively small pilot plant described in example 2.

### COMPARATIVE EXAMPLE 2

### Process Not According to the Invention

In the traditional process for mixing in very reactive crosslinkers, 120 kg of HTV rubber A are blended with 1.8% of di(4-methylbenzoyl) peroxide (=2.16 kg of paste, 50% strength in silicone oil) and 1.2% of liquid color paste FL Blau-5015 on a large standard roll mill comprising two water-cooled steel rolls (each 550 mm in diameter; 2 m long). Owing to the oily consistency of the additives, these have to be added a little at a time to the milled sheet so that no detachment of rubber from the rolls rotating at different speeds and consequently losses occur. After an addition time of at least 20 minutes, the actual homogenization time of a further 15 minutes commences and only then does offtake to the downstream strainer-extruder commence. The 100 μm purification step and the packaging of the cut product form in a manner analogous to example 1 takes a further 25-30 minutes to enable local heating above the critical rubber temperature of this crosslinking system of 65° C., i.e. partial vulcanization of the crosslinking-active product, to be avoided.

The average productivity of the standard roll mill is therefore less than 125 kg/h when using such additives which tend to set-off. At a larger amount of mixture per unit time, there is a risk of inhomogeneities in the sales product and thus processing problems in processing by extrusion, i.e. at the customer's premises. These can also be recognized in the quality control, in particular the specific comparison of the vulcameter values of various roll mill mixtures (crosslinking rate as rapid test), of a batch.

In contrast, the continuous mixing process of the invention, demonstrated in example 1, leads even in the case of low-temperature crosslinkers to a higher quality in respect of difficult additives and in particular to a significantly higher productivity of the process.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for the continuous production of organopolysiloxane compositions which vulcanize at elevated temperature and have a viscosity measured at 25° C. of at least 500 Pa·s, which comprises mixing and homogenizing high-viscosity organopolysiloxanes and crosslinking additives in a kneading cascade having at least two kneading chambers which are arranged in series proximate one another, containing two axially parallel kneading tools which can be driven in the same or opposite directions, the chambers in communication with one another by means of openings transverse to the axes of the kneading tools, with the first kneading chamber having a feed opening and a last kneading chamber having a discharge opening, wherein the temperature in kneading chambers containing crosslinking additives is not more than 95° C.

2. The process of claim 1, wherein the organopolysiloxanes, the crosslinking additives, and, optionally, further additives are mixed and homogenized at a constant mass ratio.

3. The process of claim 1, wherein additives comprise one or more of accelerators, inhibitors, stabilizers, pigments, color pastes, flame-retardant or thermally conductive metal oxide additives, substances which improve the electrical properties, fillers, organopolysiloxane modifiers, structure improvers, processing aids, dispersants, hydrophobicizing agents, destructuring agents, plasticizers, bonding agents, heat stabilizers and antioxidants.

4. The process of claim 2, wherein additives comprise one or more of accelerators, inhibitors, stabilizers, pigments, color pastes, flame-retardant or thermally conductive metal oxide additives, substances which improve the electrical properties, fillers, organopolysiloxane modifiers, structure improvers, processing aids, dispersants, hydrophobicizing agents, destructuring agents, plasticizers, bonding agents, heat stabilizers and antioxidants.

5. The process of claim 1, wherein the kneading cascade comprises from 3 to 10 kneading chambers.

6. The process of claim 2, wherein the kneading cascade comprises from 3 to 10 kneading chambers.

7. The process of claim 3, wherein the kneading cascade comprises from 3 to 10 kneading chambers.

8. The process of claim 4, wherein the kneading cascade comprises from 3 to 10 kneading chambers.

9. The process of claim 1, wherein the filler content of the organopolysiloxane compositions is from 5 to 80% by weight.

10. The process of claim 2, wherein the filler content of the organopolysiloxane compositions is from 5 to 80% by weight.

11. The process of claim 3, wherein the filler content of the organopolysiloxane compositions is from 5 to 80% by weight.

12. The process of claim 4, wherein the filler content of the organopolysiloxane compositions is from 5 to 80% by weight.

13. The process of claim 5, wherein the filler content of the organopolysiloxane compositions is from 5 to 80% by weight.

14. The process of claim 6, wherein the filler content of the organopolysiloxane compositions is from 5 to 80% by weight.

15. The process of claim 7, wherein the filler content of the organopolysiloxane compositions is from 5 to 80% by weight.

16. The process of claim 8, wherein the filler content of the organopolysiloxane compositions is from 5 to 80% by weight.

17. The process of claim 1, wherein polydimethylsiloxanes whose molecules correspond to the formula (3)
(ViMe₂SiO_{1/2})_{c}(ViMeSiO)_{d}(Me₂SiO)ₑ(Me₃SiO_{1/2})_{f} (3),
where Vi is a vinyl radical and Me is a methyl radical, the nonnegative integers c, d, e and f satisfy the following relationships: c+d×1, c+f=2, 1000<(d+e)<9000, preferably 3000<(d+e)<7000, and 0<(d+1)/(d+e)<1, preferably 0<(d+1)/(d+e)<0.1, are used as the organopolysiloxane(s).

18. The process of claim 1, wherein peroxide crosslinkers selected from the group consisting of alkyl peroxides, ketal peroxides, and aroyl peroxides are admixed as crosslinking additives.

19. The process of claim 1, wherein H-Si-functional siloxanes, platinum or rhodium catalysts, and inhibitors are mixed in as crosslinking additives (H).

20. The process of claim 1, wherein the organopolysiloxane composition is fed onto a shaping discharge machine after the last kneading chamber.

21. The process of claim 1, wherein a last chamber of the kneading cascade contains pump blades for discharge of the organopolysiloxane composition.

22. The process of claim 1, wherein product exiting a last kneading chamber is conveyed to a conical twin screw extruder and extruded into a vulcanizable shaped product.
